(19) United States
(12) Patent Application Publication
(10) Pub. No.: US 2026/0239275 A1
(43) Pub. Date: Aug. 13, 2026

(54) SYSTEM AND APPARATUS FOR ALLOCATING RESOURCES IN A NETWORK AND A METHOD IN ASSOCIATION THERETO

(71) Applicant: Continental Automotive Technologies GmbH, Hannover (DE)

(72) Inventors: Reuben George Stephen, Singapore (SG); David Gonzalez Gonzalez, Egelsbach, Hessen (DE); Andreas Andrae, Frankfurt am Main (DE)

(73) Assignee: Continental Automotive Technologies GmbH, Hannover (DE)

(21) Appl. No.: 19/154,731

(22) PCT Filed: Feb. 27, 2024
(86) PCT No.: PCT/EP2024/054902

§ 371 Date: Aug. 7, 2025

(30) Foreign Application Priority Data
Feb. 28, 2023 (DE) 10 2023 201 836.5

(51) Int. Cl. H04W 64/00; H04W 72/232; H04W 72/25

(52) U.S. Cl. CPC H04W 64/00; H04W 72/232; H04W 72/25

(57) ABSTRACT

System, apparatus, device, and a method for allocating resources in a network are disclosed. The method includes determining a positioning configuration of a user device; generating a control signal based on the configuration of the user device, the control signal including a first data format and a second data format; communicating the control signal to the user device for allocating resources to indicate a position of the user device; wherein the first data format is transmitted to the user device if it is determined the user device has the positioning configuration and the second data format is transmitted to the user device if it is determined the user device does not have the positioning configuration.

### CROSS REFERENCE TO RELATED APPLICATIONS

This application is the U.S. National Phase Application of PCT International Application No. PCT/EP2024/054902, filed Feb. 27, 2024, which claims priority to German Patent Application No. 10 2023 201 836.5, filed Feb. 28, 2023, the contents of such applications being incorporated by reference herein.

### FIELD OF THE INVENTION

The present disclosure generally relates to one or both of a system and an apparatus for allocating resources in a network and in association with, for example, a User Equipment (UE) and/or a base station, usable for communication. The present disclosure further relates a method which can be associated with the system and/or the apparatus.

### BACKGROUND OF THE INVENTION

Generally, wireless networks provide network connectivity through radio interfaces to mobile communication devices or user equipment (UE), such as smart phones. Energy efficiency, power saving and positioning services that determine the location of a communication device (or UE) can be helpful in communication networks, for example, a 3rd Generation Partnership Project (3GPP) 5G (fifth generation) New Radio (NR) standard-based telecommunications network.

Current techniques may not address the issue of accurately determining the position of a mobile device in a variety of different situations and environments by a base station or a User Equipment (UE) in a communication network. This may lead to problems such as coarse location accuracy, poor performance in indoor environments due to high penetration loss and the Non-Line-of-Sight (NLOS) nature of signal propagation from the sources of positioning signals. Thus, the current techniques may not facilitate energy efficiency and power saving in an optimal manner.

The present disclosure contemplates that it would be helpful to address or at least mitigate one or more issues in relation to conventional techniques for facilitating energy efficiency and power saving when allocating resources to determine the position of a mobile device.

### SUMMARY OF THE INVENTION

According to a first aspect of the present invention, there is provided a method for determining a positioning configuration of a user device; generating a control signal based on the configuration of the user device, the control signal comprising a first data format and a second data format; and communicating the control signal to the user device for allocating resources to indicate a position of the user device; wherein the first data format is transmitted to the user device if it is determined the user device has the positioning configuration and the second data format is transmitted to the user device if it is determined the user device does not have the positioning configuration.

Advantageously, the method as described herein can provide methods for different modes of sidelink (SL) positioning resource allocation and may allow seamless backward compatibility for prior-to-Rel-18 User Equipment (UEs) which do not have sidelink (SL) positioning capability. In addition, having shared Resource Pools (RPs) can be important for utilizing sidelink (SL) resources for both communication and positioning.

In an embodiment, the first data format comprises information associated with Downlink Control Information (DCI) and Sidelink Control Information (SCI).

In an embodiment, DCI comprises a new DCI format or a modified DCI format.

In an embodiment, the new DCI format comprises at least one of: frequency resource assignment, time resource assignment and/or configuration indexes for sidelink positioning operation.

In an embodiment, the new DCI format further comprises an indication if each of the frequency resource assignment, time resource assignment and configuration indexes is shared with sidelink communication operation.

In an embodiment, the new DCI format further comprises an index to map frequency resource and time resource from a pre-determined table.

In an embodiment, SCI comprises at least one of: a new SCI format, a modified first stage SCI format and/or a modified second stage SCI format.

In an embodiment, the new SCI format comprises at least one of: a priority value, frequency resource assignment, time resource assignment, resource reservation period, source identification and/or destination identification.

In an embodiment, the new SCI format further comprises an index to map frequency resource and time resource from a pre-determined table based on a priority value.

In an embodiment, the second data format comprises information associated with DCI and SCI.

In an embodiment, DCI comprises a modified DCI format to restrict resource allocation.

In an embodiment, SCI comprises a first stage SCI format to indicate resource reservation.

In an embodiment, determining the positioning configuration comprises determining a sidelink positioning capability of the user device.

In an embodiment, there is provided a computer program comprising instructions which, when the program is executed by a computer, cause the computer to carry out at least one of the at least one of the input step and the processing step according to the method of the first aspect.

In an embodiment, there is provided a computer readable storage medium having data stored therein representing software executable by a computer, the software including instructions, when executed by the computer, to carry out at least one of the input step and the processing step according to the method of the first aspect.

In an embodiment, there is provided a device for allocating resources in a network comprising: a first module configured to obtain data associated with a positioning configuration of a user device; a second module configured to at least one of process and facilitate the method of the first aspect in a first communication mode to generate at least one output signal; and a third module configured to communicate at least one output signal, wherein the output signal corresponds to a control signal for allocating resources to indicate a position of the user device.

In an embodiment, the first communication mode comprises at least one of: configured grant type sidelink positioning resource allocation and/or dynamic sidelink positioning resource allocation.

In an embodiment, there is provided an apparatus for allocating resources in a network comprising: a first module configured to obtain data associated with a positioning configuration of a user device; a second module configured to at least one of process and facilitate the method of the first aspect in a second communication mode to generate at least one output signal; and a third module configured to communicate at least one output signal, wherein the output signal corresponds to a control signal for allocating resources to indicate a position of the user device.

In an embodiment, the second communication mode comprises allocation of sidelink positioning resources based on resource sensing and/or random selection.

In an embodiment, the apparatus corresponds to a User Equipment (UE) communicable with a device corresponding to a base station, and wherein the base station corresponds to a Next generation Node B (gNB) configured to communicate the at least one input signal to the UE.

In an embodiment, there is provided a system comprising: at least one apparatus(es); and at least one device(s), wherein the apparatus(es) and the device(s) are capable of being coupled via at least one of wired coupling and wireless coupling.

Advantageously, the system as disclosed herein can have energy efficiency and power saving in a network through effective allocation of resources in a shared resource pool.

### BRIEF DESCRIPTION OF THE DRAWINGS

Embodiments of the disclosure are described hereinafter with reference to the following drawings, in which:

FIG. 1A shows a schematic diagram illustrating a system for allocating resources in a network which can include at least one apparatus, according to an embodiment of the invention.

FIG. 1B to 1I show example scenarios in association with the system of FIG. 1A, according to an embodiment of the invention.

FIG. 2 shows a schematic diagram illustrating the apparatus of FIG. 1A in further detail, according to an embodiment of the invention.

FIG. 3 shows a method in association with the system of FIG. 1A, according to an embodiment of the invention.

FIG. 4A to FIG. 4E show schematic diagrams illustrating the flow of information in association with the method of FIG. 3, according to an embodiment of the invention.

### DETAILED DESCRIPTION

The present specification discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the mobile telephone system. The computer program when loaded and executed on such a computer effectively results in an apparatus that implements the steps of the preferred method.

In some embodiments, the non-limiting term user equipment (UE) or wireless device or user device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

In some embodiments, a more general term “network node” may be used and may correspond to any type of radio network node or any network node, which communicates with a user equipment (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

The present disclosure contemplates that when a shared resource pool (RP) with sidelink (SL) communication is used for SL positioning, there are no existing procedures available for performing allocation or reservation of resources. Moreover, any such procedure should be backward compatible for prior-to-Release 18 user equipment (UE), since these UEs do not have sidelink positioning capability and would be using the resource pool only for sidelink communication. The present disclosure contemplates that approaches for resource allocation for SL positioning in a shared RP may not cover all scenarios and may not consider backward compatibility for prior-to-Release 18 user equipment (UE). Specifically, the transmitting UE may indicate whether sidelink positioning reference signals are transmitted for co-existence with sidelink communication but such a new indication may not be understood by a prior-to-Release 18 UE.

The present disclosure contemplates the possibility of indicating resource allocation for sidelink (SL) positioning in a shared resource pool (RP) with sidelink communication. In particular, the present disclosure contemplates the possibility of having methods for indicating resource allocation for SL positioning in a shared RP, for both SL communication mode 1 whereby allocation of resources is by the network gNB (or base station) and SL communication mode 2 whereby reservation of resources is by a UE.

The present disclosure contemplates having two different procedures, tailored to two types of resource allocation schemes, a Mode 1 resource allocation like in sidelink communication, where the network gNB (or base station) is responsible for performing the resource allocation and indication, and a Mode 2 resource allocation like in sidelink communication, where the UEs autonomously choose the resource allocation and perform the indication. For Mode 1, the present disclosure contemplates a new downlink control indication (DCI) format for Release 18 UEs and beyond, and/or suitably modifying the existing DCI format 3_0 meant for prior-to-Release 18 UEs. For Mode 2, the present disclosure contemplates a new sidelink control information (SCI) stage in addition to the already existing 1 st and 2nd stage SCI and in addition to modifying the indications in the 1 st stage SCI and/or the 2nd stage SCI.

In the above manner, a method can be provided on resource allocation for a SL positioning UE using a shared RP with communication, in accordance with an embodiment of the invention. In addition, backward compatibility for prior-to-Release 18 UEs can be ensured when allocating SL positioning resources in a shared RP. Power saving and energy consumption efficiency can therefore possibly be facilitated in the network, in accordance with an embodiment of the invention.

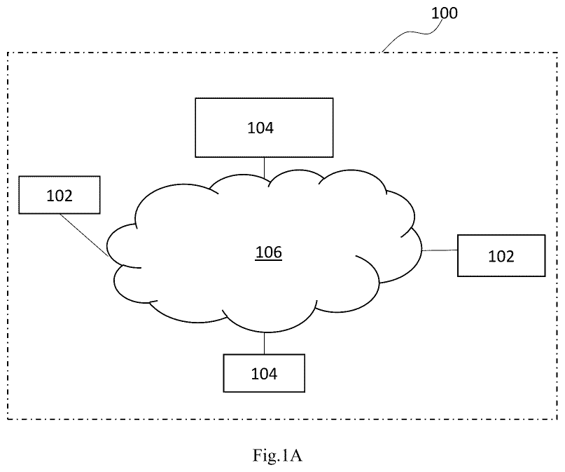

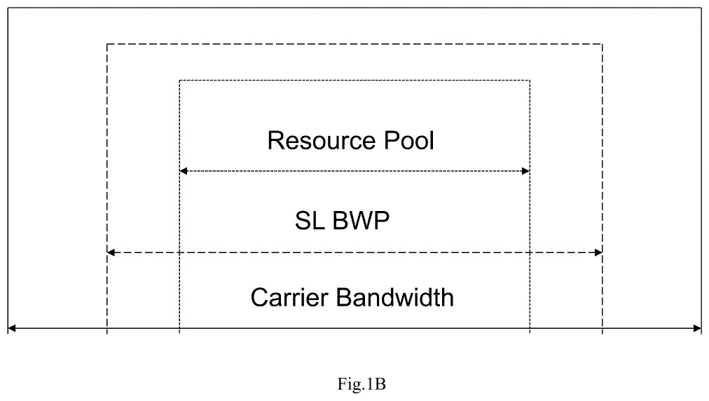

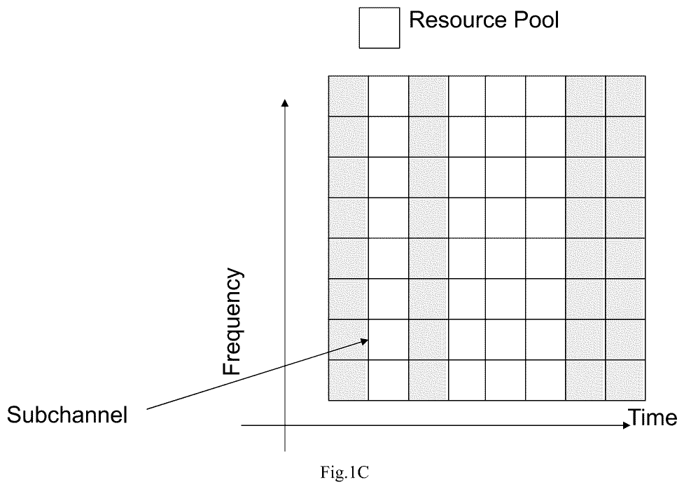

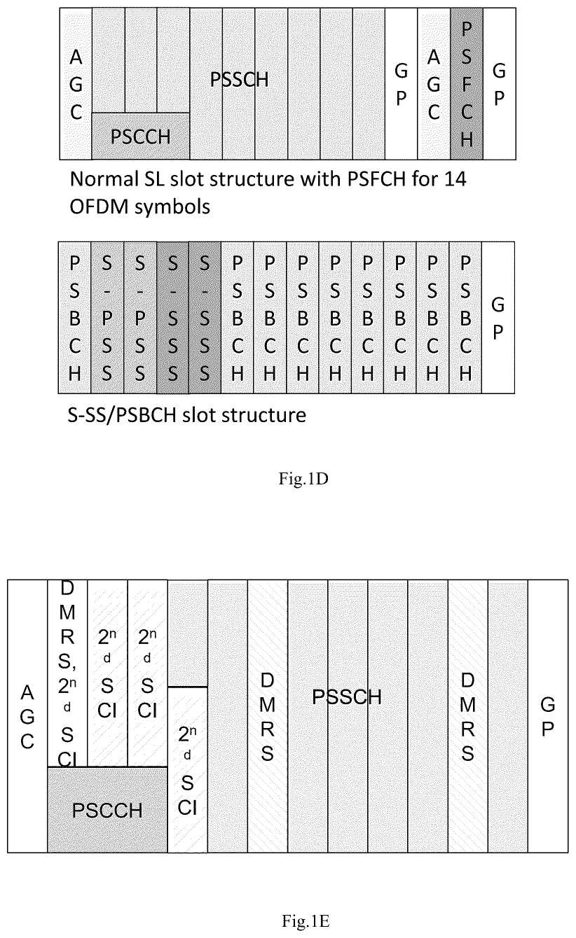

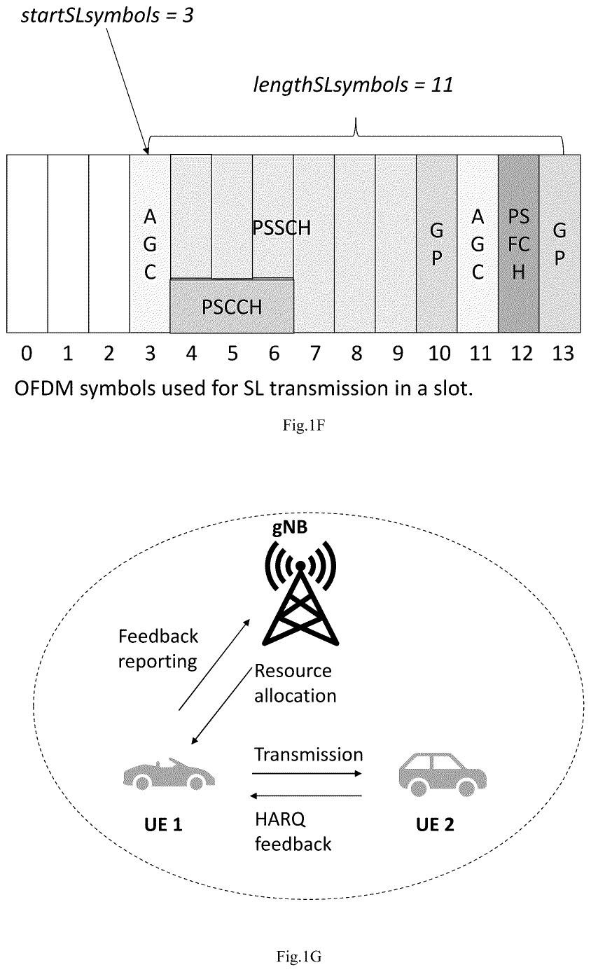

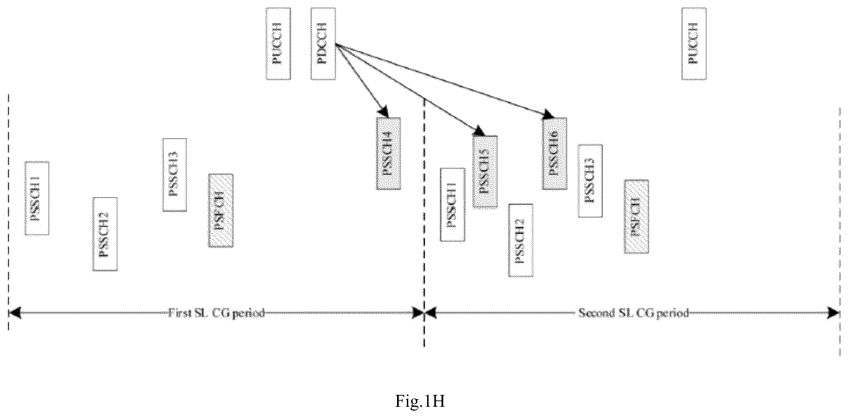

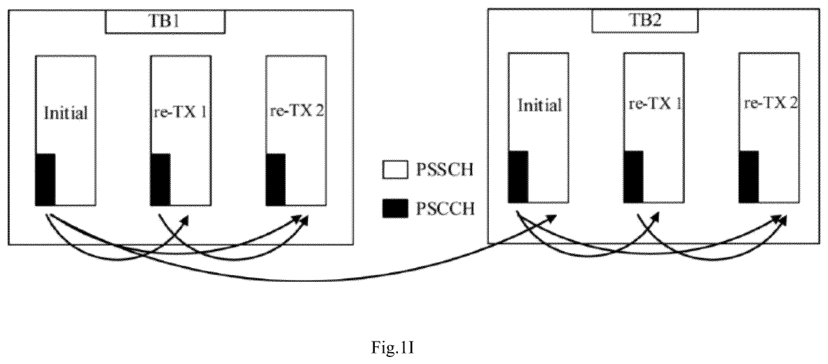

The foregoing will be discussed in further detail with reference to FIG. 1 to FIG. 4 hereinafter.

Referring to FIG. 1A, a schematic diagram illustrating a system 100 for allocating resources in a network is shown, according to an embodiment of the invention. The system 100 can, for example, be suitable for facilitating energy and improve power efficiency, in accordance with an embodiment of the invention.

As shown, the system 100 can include one or more apparatuses 102, at least one device 104 and, optionally, a communication network 106, in accordance with an embodiment of the invention.

The apparatus(es) 102 can be coupled to the device(s) 104. Specifically, the apparatus(es) 102 can, for example, be coupled to the device(s) 104 via the communication network 106, in accordance with an embodiment of the invention.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the invention.

The apparatus(es) 102 can, for example, be associated with or correspond to or include one or more user equipment (UE) which can carry one or more computers, in accordance with an embodiment of the invention. For example, an apparatus 102 can correspond to a UE carrying at least one computer (e.g. an electronic device or module having computing capabilities such as an electronic mobile device which can be carried into a vehicle or an electronic module which can be installed in a vehicle, in accordance with an embodiment of the invention) which can be configured to perform one or more processing tasks in association with adaptive/dynamic/gradual control, in accordance with an embodiment of the invention.

In an embodiment, the apparatus(es) 102 can, for example, be configured to receive one or more input signals and perform at least one processing task based on the input signal(s) in a manner to generate one or more output signals. The input signal(s) can, for example, be communicated from the device(s) 104 and received by the apparatus(es) 102, in accordance with an embodiment of the invention. In an alternate embodiment, the device(s) 104 can be configured to receive the one or more input signals and perform at least one processing task based on the input signal(s) in a manner to generate one or more output signals. In this embodiment, the input signal(s) can, for example, be communicated from the apparatus(es) 102 and received by the device(s) 104.

The input signal can be associated with a positioning configuration of a user device (or UE). Specifically, the positioning configuration may include a sidelink positioning capability or a positioning resource allocation configuration of the user device (or UE). As a possible option, the output signal(s) can, for example, be communicated from the device(s) 104, in accordance with an embodiment of the invention. The output signal may correspond to a control signal for allocating resources in a shared resource pool of a network. The apparatus(es) 102 and device(s) 104 will be discussed later in further detail with reference to FIG. 2, according to an embodiment of the invention.

The device(s) 104 can, for example, be associated with/correspond to at least one base station, where the at least one base station can be a Next Generation Node B (gNB). Moreover, the device(s) 104 can, for example, be configured to carry/be associated with/include one or more computers (e.g., an electronic device/module having computing capabilities) which can, for example, be configured to perform one or more processing tasks in association with the base station. The device(s) 104 can be configured to receive one or more input signals which can be communicated from the apparatus(es) 102, in accordance with an embodiment of the invention. The device(s) 104 can, for example, perform one or more processing tasks in association with dynamic/adaptive/gradual control on the input signal(s) in a manner so as to generate at least one output signal. This will be discussed later in further detail in the context of an example scenario, in accordance with an embodiment of the invention.

The communication network 106 can, for example, correspond to an Internet communication network, a cellular-based communication network, a wired-based communication network, a Global Navigation Satellite System (GNSS) based communication network, a wireless-based communication network, or any combination thereof. Communication (e.g., between the apparatuses 102 and/or between the apparatus(es) 102 and the device(s) 104) via the communication network 106 can be by manner of one or both of wired communication and wireless communication.

The apparatus(es) 102 can, for example, be configured to generate at least one input signal and perform at least one processing task in association with dynamic/adaptive/gradual control on the input signal(s) in a manner so as to generate at least one output signal. Moreover, the device(s) 104 can, for example, be configured to generate (and communicate) the output signal(s) to the apparatus(es) 102, in accordance with an embodiment of the invention. Accordingly, the device(s) 104 can generate a control signal for allocating resources to the apparatus(es) 102. This will be discussed, in accordance with an embodiment of the invention, in the context of example scenarios with reference to FIG. 1B to FIG. 1I, hereinafter.

FIG. 1B to 1I show example scenarios in association with the system of FIG. 1A, according to an embodiment of the invention. Specifically, FIG. 1B shows an example of a relationship between Sidelink Bandwidth Part (SL BWP) and a Resource Pool (RP). As shown in the Figure, at most one SL BWP can be configured on a carrier bandwidth such that the configured SL BWP is to be used for both transmitting and receiving Sidelink (SL) signals and channels.

FIG. 1C shows an example of a graph illustrating the relationship between frequency and time in relation to subchannel and resource pool. In an embodiment, a User Equipment (UE or user device) can be configured with one or multiple Sidelink Resource Pools (SL RPs). The time-domain can have minimum granularity one slot and can contain non-contiguous slots while the frequency-domain can have minimum granularity one subchannel (with multiple consecutive Physical Resource Blocks) such that the subchannels must be continuous, in accordance with an embodiment of the invention. In an embodiment, the resource block (RB) may be defined by

$${N}_{sc}^{RB} = 12$$

consecutive subcarriers in the frequency domain while the Common Resource Bloc (CRB) can be numbered from 0 onwards in the frequency domain for subcarrier spacing configuration μ such that

$${n}_{CRB}^{μ} = ⌊ \frac{k}{{N}_{sc}^{RB}} ⌋ .$$

The physical RB can be defined within the SL BWP and numbered from 0 to

$${N}_{BWP}^{size , μ} - 1.$$

If the SL BWP starts relative to CRB 0, the CRB can be defined by

$${n}_{CRB}^{μ} = {n}_{PRB}^{μ} + {N}_{BWP}^{start , μ} ; {N}_{BWP}^{start , μ} .$$

FIG. 1D shows two examples of a SL slot structure. As shown in the Figure, the normal slot structure contains physical sidelink control channel (PSCCH), physical sidelink shared channel (PSSCH) and possibly physical sidelink feedback channel (PSFCH). The sidelink synchronization signal block (S-SSB) may contain sidelink synchronization signals (S-SS) and physical sidelink broadcast channel (PSBCH). PSCCH and PSCCH will be discussed in further detail below, in accordance with an embodiment of the invention.

In an embodiment, physical sidelink control channel (PSCCH) can be used to carry SL control information related to SL resource allocation, sensing and decoding of PSSCH. It may occupy two or three orthogonal frequency-division multiplexing (OFDM) symbols in time domain and {10, 12, 15, 20, 25} Physical Resource Blocks (PRBs) in the frequency domain which are pre-configured by the network. A sidelink control information (SCI) format 1-A may be carried on PSCCH as a 1st stage SCI, in accordance with an embodiment of the invention. Table 1 below shows an example of the fields in a SCI format 1-A, in accordance with an embodiment of the invention.

TABLE 1
Fields in SCI format 1-A

| Priority | 3 bits |
|---|---|
| Frequency resource assignment | When used to indicate resources for current transmission and one $retransmission : {log}_{2} ( \frac{{N}_{subchannel}^{SL} ( {N}_{subbchannel}^{SL} + 1 )}{2} ) bits$ |
| | When used to indicate resources for current transmission and two re- |
| | $transmissions : {log}_{2} ( \frac{{N}_{subchannel}^{SL} ( {N}_{subbchannel}^{SL} + 1 ) ( 2 {N}_{subchannel}^{SL} + 1 )}{6} ) bits$ |
| Time resource | When used to indicate resources for current transmission and one |
| assignment | retransmission: 5 bits |
| | When used to indicate resources for current transmission and two |
| | retransmissions: 9 bits |
| PSSCH DMRS pattern | ${log}_{2} {N}_{pattern} bits$ |
| 2^{nd}-stage SCI | 2 bits |
| format | 00: format 2-A, 01: format 2-B, 10 and 11: reserved |
| Beta offset indicator | 2 bits |
| Number of PSSCH | 1 bit |
| DMRS port | |
| Modulation and coding | 5 bits |
| scheme (MCS) | |
| MCS table indicator | 0-2 bits |
| PSFCH overhead | If PSFCH period is 2 or 4: 1 bit |
| indication | Otherwise: 0 bits |
| Resource reservation | 4 bits |
| period | |
| Reserved | 2-4 bits, (pre-)configured by gNB, value set to zero |

FIG. 1E shows an example of a physical sidelink shared channel (PSSCH) in a slot structure. In an embodiment, PSSCH can be used to carry 2nd-stage SCI and data information, whereby the 2nd-stage SCI can minimize the number of bits in the 1 st-stage SCI and can ensure that the number of bits in the 1 st-stage SCI do not change with, for example transmission type, propagation channel condition etc. The 2nd-stage SCI can also be allowed to use different formats and code rates.

In an example embodiment, there may be two 2nd-stage SCI formats, 2-A and 2-B. The 2-B format may include groupcast communication with SL Hybrid Automatic Repeat Request (HARQ) feedback based on geographical location and communication range while the 2-A format may include other scenarios such as transmissions that do not require SL HARQ feedback, unicast that requires SL HARQ feedback and groupcast that requires Acknowledgement (ACK) or Negative-Acknowledgement (NACK) feedback. Table 2 below shows an example of the fields in SCI format 2-A and 2-B, in accordance with an embodiment of the invention.

FIG. 1F shows an example of OFDM symbols used for SL transmission in a slot. In an embodiment and shown in the Figure, resource allocation may include a time-domain whereby higher layer parameters such as startSLsymbols and lengthSLsymbols may configure the start and length of time-domain symbols that can be used for SL transmission in the slot. Resource allocation may also include a frequency-domain whereby granularity can be one subchannel, with size N₁ with consecutive PRBs. The frequency-domain may be determined by initial subchannel index and the number of allocated subchannels and the PSCCH may be transmitted only in a first subchannel of PSSCH and may occupy N₂ consecutive PRBs within a subchannel, where N₂≤N₁.

FIG. 1G shows an example of a Mode 1 SL dynamic resource allocation. In this mode, the network gNB (or base station) can, for example, allocate or schedule transmission resources within sidelink resource pool (SL RP) to the user equipment (UE or user device) using downlink control information (DCI). The UE (or user device) may adopt resources dynamically allocated by the gNB (or base station) in aperiodic traffic such that the UE sends a scheduling request (SR) and buffer status report (BSR) to the gNB (or base station) and the network allocates SL transmission resource for the UE according to buffer information. The DCI may include DCI format 3_0 for the gNB (or base station) to provide SL resource allocation in Mode 1. The DCI format 3_0 may be scrambled by sidelink radio network temporary identifier (SL-RNTI) whereby dynamic SL resource allocation may be scheduled by the network gNB (or base station). In another embodiment, the DCI format 3_0 may be scrambled by sidelink configured scheduling radio network temporary identifier (SL_CS_RNTI) such that a semipersistent scheduled Type 2 SL configured grant (CG) can be activated or deactivated by the network gNB (or base station).

In an embodiment, mode 1 scheduling information may be included in DCI format 3_0. A resource pool (RP) index may be required when multiple mode 1 SL RPs are configured and a SL resource allocation information may include the gNB (or base station) allocating up to N SL resources to the UE (or user device) where 1≤N≤Nₘₐₓ and Nₘₐₓ=2 or 3. Table 3 below shows an example of the SL resource allocation information, in accordance with an embodiment of the invention.

TABLE 3
SL resource allocation information

| Time gap | Indicates time gap in no. of slots between first SL transmission resource | |
|---|---|---|
| | and slot in which SL scheduling DCI is provided | |
| Frequency | Lowest index of subchannel allocated for initial transmission | |
| resource | Frequency size of allocated SL transmission resource(s) in no. of | |
| assignment | subchannels | |
| Time resource | Indicates slot gaps of N-1 SL transmission resources, other than first | |
| assignment | resource, relative to first SL transmission resource | |
| PUCCH | Information related to PUCCH transmission resource for UE reporting | |
| resource | of SL HARQ feedback to gNB | |
| allocation info | PUCCH | gNB configures PUCCH resource set by RRC signaling and |
| | resource | indicates specific PUCCH resource for HARQ reporting |
| | indicator | using this field |
| | PSFCH- | Indicates time gap between SL HARQ report received in |
| | to-HARQ | PSFCH and PUCCH resource to be used for relaying SL |
| | feedback | HARQ report to gNB (in no. of slots corresponding to |
| | timing | PUCCH SCS) |
| | indicator | |
| HARQ | HARQ process number associated with SL transmission resource(s) | |
| process | allocated by gNB | |
| number | | |
| New Data | Indicates whether current transmission is the initial transmission of a TB | |
| Indicator | | |
| (NDI) | | |
| Configuration | When UE configured with SL-CS-RNTI, DCI format 3_0 can be | |
| index | used to activate/deactivate SL Type-2 CG. | |
| | When UE configured with multiple Type-2 CGs by network, index | |
| | indicates exact Type-2 CG to be activated/deactivated by DCI | |
| | When UE not configured with SL-CS-RNTI, length of field is 0 | |
| Counter SL | UE uses this info to determine the right number of info bits when | |
| assignment | generating the HARQ-ACK codebook to report to the network gNB | |
| index | | |

FIG. 1H shows an example of retransmission scheduling for sidelink configured grant (SL CG). In this embodiment, there may be periodically occurring resources such that if configured, the UE can use to transmit SL data without requesting resource from the network. An example embodiment may include type 1 SL CG whereby the network may configure SL CG resources and transmission parameters for the UE by radio resource control (RRC) signaling. Another example embodiment may include type 2 SL CG whereby the network may configure a portion of SL transmission parameters for the UE by RRC signaling and activates SL CG using the DCI format 3_0 signaling in PDCCH where the remaining SL transmission parameters are provided in the DCI.

Moreover, the network may allocate N SL transmission resources within each SL CG period where 1≤N≤Nₘₐₓ and Nₘₐₓ may be network configured (2 or 3). The network may also activate or deactivate SL CG by DCI format 3_0 that is scrambled by SL-CS-RNTI and the new data indicator (NDI) field may also be set to 0. For example, if the “hybrid automatic repeat request (HARQ) process number” field is set to all 0, it may be used to activate SL CG. On the other hand, if the “hybrid automatic repeat request (HARQ) process number” field is set to all 1 and the “frequency resource assignment” field is also set to all 1, it can be used to deactivate SL CG.

In an example embodiment, an indication message to enable or disable monitoring may be sent through PDCCH/MAC CE (UE specific) and system information to all UEs for UE(s). The indication message can be sent to the UE so as to stop or temporarily disable monitoring while monitoring is re-configured for update when the gNB determines re-training or switching during monitoring operation.

FIG. 1I shows an example of SL resource reservation for same transmission block (TB) and SL resource reservation for different TB. More generally, it shows an example of a Mode 2 SL resource allocation. In this mode and in accordance with an embodiment, the UE (or user device) can, fully on its own, select time-frequency resources from a SL RP based on resource sensing or random selection. The UE may send sidelink control information (SCI) to reserve or announce time-frequency resources to be used for SL transmissions in future. The “time resource assignment” and the “frequency resource assignment” fields in the SCI format 1-A can provide information for reserving resources for the same TB, in accordance with an embodiment of the invention. In this mode, it may also indicate up to N time-frequency resources, including resources for current transmission, for transmitting the current TB, where 1≤N≤Nₘₐₓ and Nₘₐₓ=2 or 3. Furthermore, the “Resource reservation period” field can reserve time-frequency SL resources in the next time period for transmission of another TB.

The above-described aspect(s) of the system 100 of the present invention can also apply analogously (all) the aspect(s) of a below described apparatus 102 and device 104 of an aspect of the present invention. Likewise, all below described aspect(s) of the apparatus 102 and device 104 of an aspect of the invention can also apply analogously (all) the aspect(s) of above-described system 100 of the invention.

The aforementioned apparatus(es) 102 or User Equipment (UE) will be discussed in further detail with reference to FIG. 2 hereinafter.

Referring to FIG. 2, a schematic diagram illustrating an apparatus 102 is shown in further detail in the context of an example implementation 200, according to an embodiment of the invention.

In the example implementation 200, the apparatus 102 can correspond to an electronic module 200a. The electronic module 200a can, in one example, correspond to a mobile device which can, for example, be carried into the vehicle by a user, in accordance with an embodiment of the invention. In another example, the electronic module 200a can correspond to an electronic device which can be installed/mounted in the vehicle, in accordance with an embodiment of the invention. In this regard, the electronic module 200a can be considered to be carried by the vehicle (e.g., either carried into the vehicle by a user or installed/mounted in the vehicle).

It is contemplated that the electronic module 200a can be capable of performing one or more processing tasks in association with adaptive/dynamic/gradual control related processing, in accordance with an embodiment of the invention.

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the invention.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the invention. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the invention.

In one example, the first module 202 can correspond to a hardware-based receiver which can be configured to receive one or more input signals. The input signal(s) can, for example, be communicated from the device(s) 104 (or base station e.g., a gNB), in accordance with an embodiment of the invention.

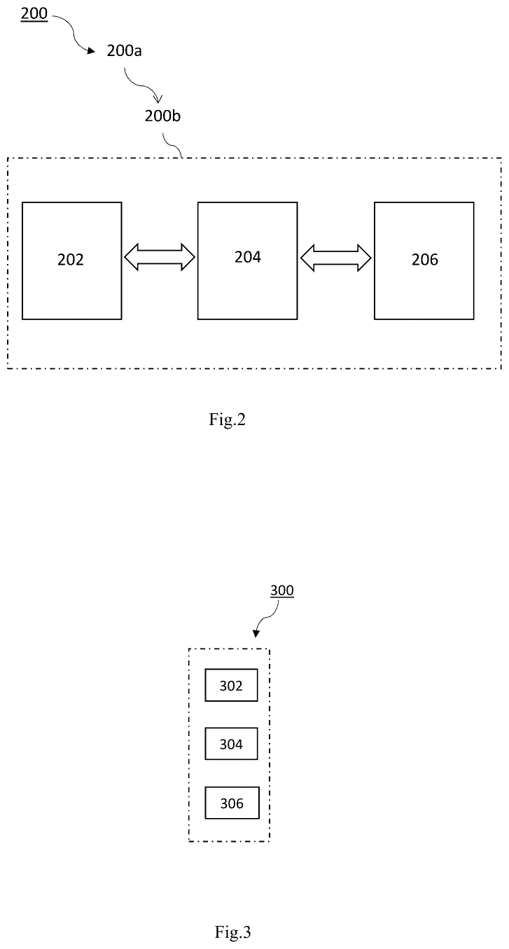

The second module 204 can, for example, correspond to a hardware-based processor which can be configured to perform one or more processing tasks (e.g., in a manner so as to generate one or more output signals) as will be discussed later in further detail with reference to FIG. 3, in accordance with an embodiment of the invention.

The third module 206 can correspond to a hardware-based transmitter which can be configured to communicate one or more output signals from the electronic module 200a. The output signal(s) can, for example, include one or more instructions/commands/control signals in association with the aforementioned dynamic/adaptive/gradual control configuration/determination strategy so as to facilitate efficiency (e.g., power/energy efficiency and/or communication efficiency), in accordance with an embodiment of the invention. For example, the output signal(s) can be a control signal(s) to allocate resources in order to indicate a position of the user device (or UE).

The present disclosure contemplates the possibility that the first and second modules 202, 204 can be an integrated software-hardware based module, for example, an electronic part which can carry a software program or algorithm in association with receiving and processing functions or an electronic module programmed to perform the functions of receiving and processing. The present disclosure further contemplates the possibility that the first and third modules 202, 206 can be an integrated software-hardware based module, for example an electronic part which can carry a software program or algorithm in association with receiving and transmitting functions or an electronic module programmed to perform the functions of receiving and transmitting. The present disclosure yet further contemplates the possibility that the first and third modules 202, 206 can be an integrated hardware module, for example a hardware-based transceiver, capable of performing the functions of receiving and transmitting.

The apparatus 102 (or UE) can, for example, be further configured to process the input signal(s), as will be discussed later in further detail with reference to FIG. 3, in a manner so as to generate one or more output signals in a manner so as to facilitate efficiency, for example power efficiency or energy efficiency, in accordance with an embodiment of the invention. In one specific example, the output signal(s) can include one or more control signals to facilitate some form of dynamic/adaptive/gradual control configuration/determination strategy so as to facilitate efficiency, for example power efficiency or energy efficiency, in accordance with an embodiment of the invention. For example, the output signal(s) can be a control signal(s) for allocating resources to indicate a position of a user device (or UE).

In an alternative embodiment, the schematic diagram of FIG. 2 may illustrate a device 104 in the context of the example implementation 200, according to an embodiment of the invention.

In particular, the example implementation 200 together with its modules 200a, 200b, 202, 204 and 206 as described above may correspond to a device 104 such as a base station (or gNB). For example, the electronic module 200a having the casing 200b, the first module 202, the second module 204 and the third module 206 may be installed in a base station (or gNB). In an example, the first module 202 can correspond to a hardware-based receiver which can be configured to receive one or more input signals which can, for example, be communicated from the apparatus 102 (or UE or user device), in accordance with an embodiment of the invention.

The device 104 (or base station) can, for example, be further configured to process the input signal(s), as will be discussed later in further detail with reference to FIG. 3, in a manner so as to generate one or more output signals in a manner so as to facilitate efficiency, for example power efficiency or energy efficiency, in accordance with an embodiment of the invention. In one specific example, the output signal(s) can include one or more control signals to facilitate some form of dynamic/adaptive/gradual control configuration/determination strategy so as to facilitate efficiency, for example power efficiency or energy efficiency, in accordance with an embodiment of the invention. For example, the output signal(s) can be a control signal(s) for allocating resources to indicate a position of a user device (or UE).

The above-described aspect(s) of the apparatus 102 and device 104 of the present invention can also apply analogously (all) the aspect(s) of a below described processing/communication method of an aspect of the present invention. Likewise, all below described aspect(s) of the method of the invention can also apply analogously (all) the aspect(s) of above described apparatus 102 and device 104 of an aspect of the invention. It is to be appreciated that these remarks apply analogously to the earlier discussed system 100 of the present disclosure.

Referring to FIG. 3, a method 300 (or a communication method) for allocating resources in association with the system 100 is shown, according to an embodiment of the invention.

The method 300 can, for example, be suitable for facilitating energy efficiency, network optimization and power saving in accordance with an embodiment of the invention.

The method 300 can include any one of an input step 302, a processing step 304 and an output step 306, or any combination thereof, in accordance with an embodiment of the invention.

In an embodiment, the processing method 300 can include the input step 302. In another embodiment, the processing method 300 can include the input step 302 and the processing step 304. In another embodiment, the processing method 300 can include the input step 302, the processing step 304 and the output step 306. In yet another embodiment, the processing method 300 can include the processing step 304 and one or both of the input step 302 and the output step 306. In yet a further embodiment, the processing method 300 can include the input step 302, the processing step 304 and the output step 306. In yet a further additional embodiment, the processing method 300 can include the processing step 304. In yet another further additional embodiment, the processing method 300 can include any one of or any combination of the input step 302, the processing step 304 and the output step 306 (i.e., the input step 302, the processing step 304 and/or the output step 306).

With regard to the input step 302, one or more input signal(s) can be received. For example, the input signal(s) can be communicated from the apparatus 102 and can be received by the device 104, in accordance with an embodiment of the invention. In an alternative embodiment, the input signal(s) can be received by the apparatus 102.

The input step 302 can include receiving at least one input signal associated with a positioning configuration of a user device (or UE). Specifically, the positioning configuration may include a sidelink positioning capability or a positioning resource allocation configuration of the user device (or UE). In an embodiment, the input signal(s) may be generated by the apparatus 102 and transmitted from the apparatus 102 to the device 104. Alternatively, the input signal(s) may be generated and received by the apparatus 102 to advance to the processing step 304. For example, the input signal(s) may be generated by a transmitting UE (or user device) and received by a receiving UE (or user device).

With regard to the processing step 304, at least a processing task can be performed in association with the received input signal(s) in a manner so as to generate one or more output signals, in accordance with an embodiment of the invention.

The processing step 304 may include at least one of: determining a positioning configuration of a user device; generating a control signal based on the configuration of the user device, the control signal comprising a first data format and a second data format and communicating the control signal to the user device for allocating resources to indicate a position of the user device. The first data format is transmitted to the user device if it is determined the user device has the positioning configuration and the second data format is transmitted to the user device if it is determined the user device does not have the positioning configuration.

The first data format may include information associated with Downlink Control Information (DCI) and Sidelink Control Information (SCI). The DCI may include a new DCI format or a modified DCI format. The new DCI format may include at least one of: frequency resource assignment, time resource assignment and/or configuration indexes for sidelink (SL) positioning operation. The new DCI format may also include an indication if each of the frequency resource assignment, time resource assignment and configuration indexes is shared with SL communication operation. The new DCI format may also further include an index to map frequency resource and time resource from a pre-determined table. The SCI may include at least one of: a new SCI format, a modified first stage SCI format and/or a modified second stage SCI format. The new SCI format may include at least one of: a priority value, frequency resource assignment, time resource assignment, resource reservation period, source identification and/or destination identification. The new SCI format may also include an index to map frequency resource and time resource from a pre-determined table based on a priority value.

The second data format may include information associated with DCI and SCI such that the DCI includes a modified DCI format to restrict resource allocation and the SCI can include a first stage SCI format to indicate resource reservation. The processing step 304 may further include determining a sidelink positioning capability of the user device.

With regards to the output step 306, the output signal(s) can, for example, be communicated, as an option, in accordance with an embodiment of the invention. For example, the output signal(s) can optionally be communicated from the device 104. In a more specific example, the output signal(s) can optionally be communicated from the device 104 to one or both of at least apparatus 102, in accordance with an embodiment of the invention. The apparatus 102 (or UE or user device) may also perform the input step 302, the processing step 304 and the output step 306, in accordance with an example embodiment of the invention.

The present disclosure further contemplates a computer program (not shown) which can include instructions which, when the program is executed by a computer (not shown), cause the computer to carry out the input step 302, the processing step 304 and/or the output step 306 as discussed with reference to the method 300. For example, the computer program can include instructions which, when the program is executed by a computer, cause the computer to carry out the input step 302 and/or the processing step 304, in accordance with an embodiment of the invention.

The present disclosure yet further contemplates a computer readable storage medium (not shown) having data stored therein representing software executable by a computer (not shown), the software including instructions, when executed by the computer, to carry out the input step 302, the processing step 304 and/or the output step 306 as discussed with reference to the method 300. For example, the computer readable storage medium can have data stored therein representing software executable by a computer, the software including instructions, when executed by the computer, cause the computer to carry out the input step 302 and/or the processing step 304, in accordance with an embodiment of the invention.

Further in view of the foregoing, it is appreciable that the present disclosure generally contemplates an apparatus 102 and/or a device 104 for allocating resources in a network which can include a first module 202, a second module 204 and/or a third module 206.

The first module 202 can be configured to receive one or more input signals. The input signal(s) can, for example, be associated a model quality threshold range.

The second module 204 can be configured to process and/or facilitate processing of the input signal(s) according to the method 300 as discussed earlier to generate one or more output signals in a first communication mode (e.g. Mode 1 as shown in FIG. 1G) or a second communication mode (e.g. Mode 2 as shown in FIG. 1I). The first communication mode may include at least one of: configured grant type sidelink positioning resource allocation and/or dynamic sidelink positioning resource allocation. The second communication mode may include allocation of sidelink positioning resources based on resource sensing and/or random selection.

The third module 206 can be configured to communicate one or more output signals. The output signal(s) can, for example, correspond to one or more control signals for allocating resources to indicate a position of the user device.

In one embodiment, the apparatus 102 can correspond to a User Equipment (UE) which can communicate with a device 104 corresponding to a base station. The base station can, for example, correspond to a Next generation Node B (gNB) which can be configured to communicate one or more signals (e.g., input signal(s)) to the UE.

Yet further in view of the foregoing, it is appreciable that the present disclosure generally contemplates a system 100 which can include one or more apparatuses 102 and one or more devices 104. The apparatus(es) 102 and the device(s) 104 can, for example, be capable of being coupled via wired coupling and/or wireless coupling.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, the possibility of the output signal(s) being communicated from the apparatus(es) 102 was discussed. It is appreciable that the output signal(s) need not necessarily be communicated from the apparatus(es) 102. Specifically, the possibility that the output signal(s) need not necessarily be communicated outside of the apparatus(es) 102 is contemplated, in accordance with an embodiment of the invention. More specifically, the output signal(s) can, for example, correspond to internal command(s)/instruction(s) (e.g., communicated only within an apparatus 102) for adaptively controlling operational configuration of an apparatus 102, in accordance with an embodiment of the invention.

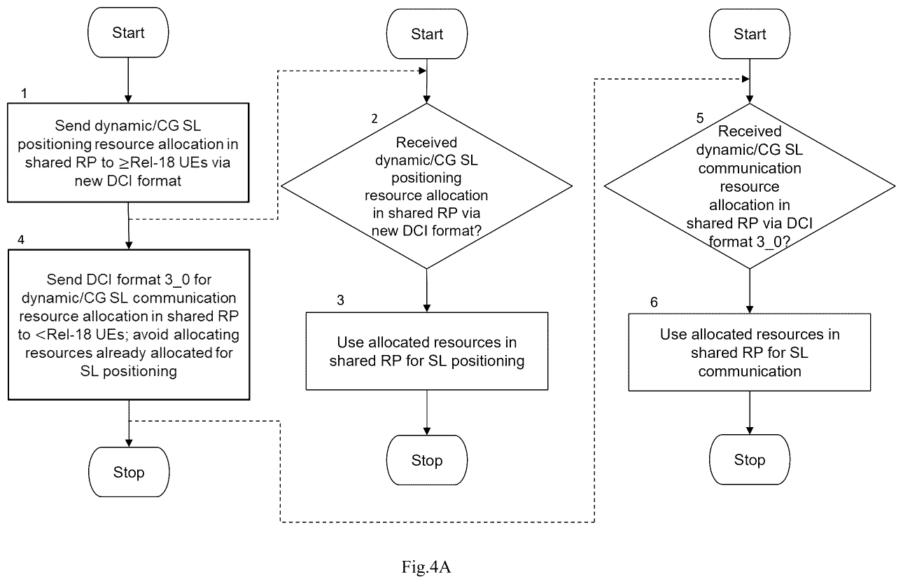

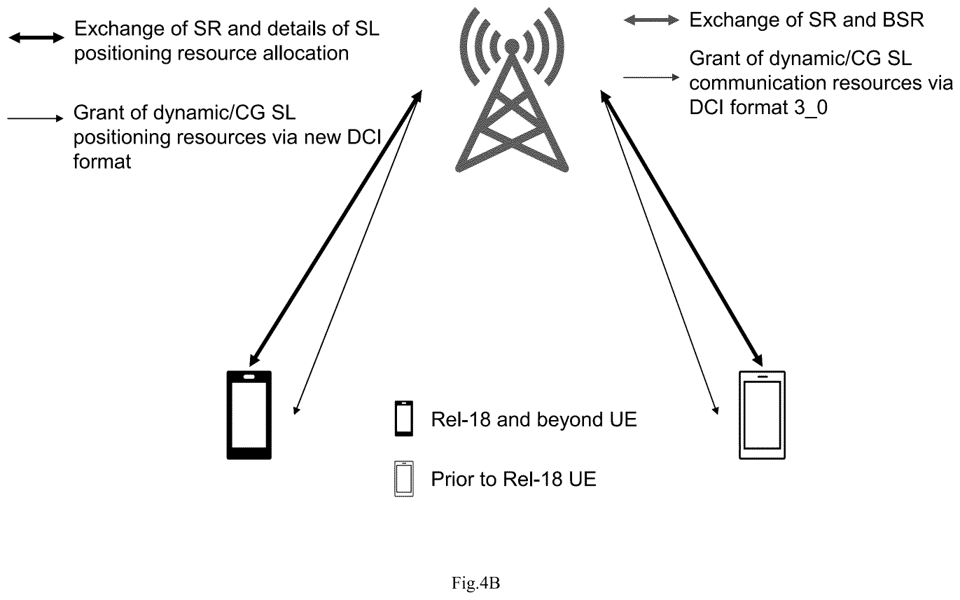

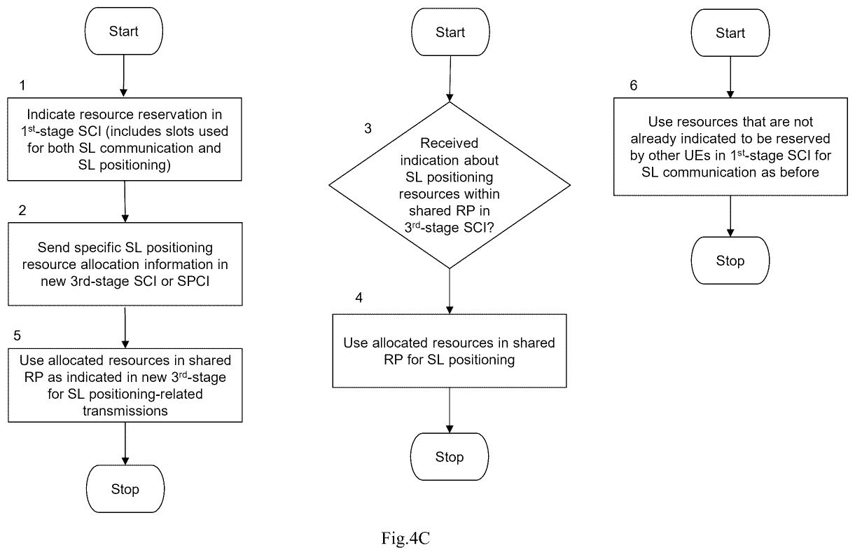

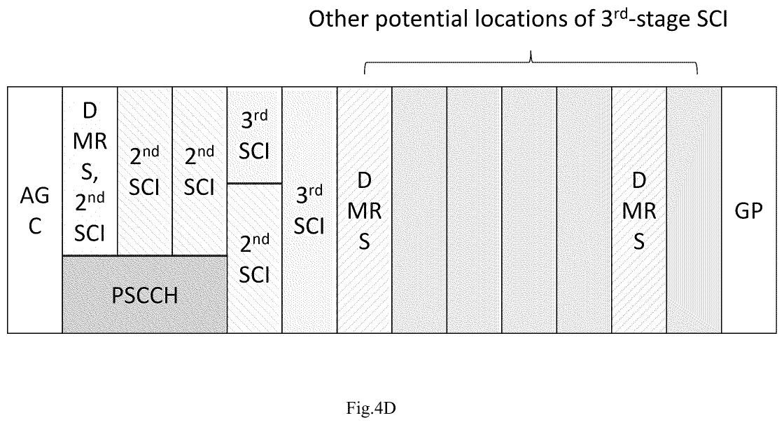

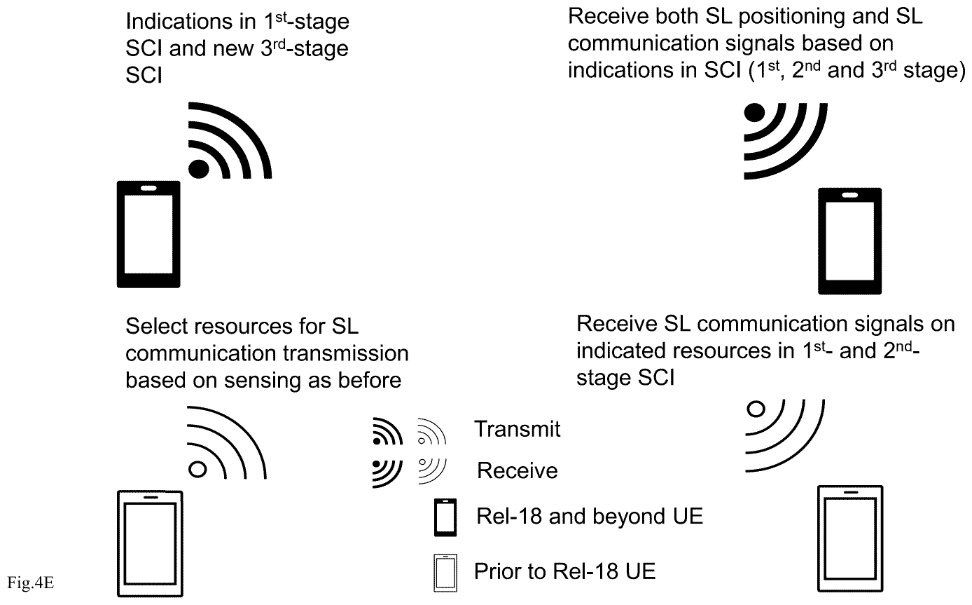

FIG. 4A to FIG. 4E show schematic diagrams illustrating the flow of information in association with the method of FIG. 3, according to an embodiment of the invention.

The present disclosure contemplates that a method can be provided on resource allocation for a sidelink (SL) positioning user equipment (UE) using a shared resource pool (RP) with communication, in accordance with an embodiment of the invention. In addition, backward compatibility for prior-to-Release 18 UEs can be ensured when allocating SL positioning resources in a shared RP. Specifically, it is contemplated that the method may include two cases depending on type of SL positioning resource allocation. In the first case whereby dynamic and configured grant type SL positioning resource allocation like dynamic and configured grant type resource allocation in mode 1 for SL communication, the network gNB (or base station) sends downlink control information (DCI) in a new format and modifies DCI format 3_0 if required. This may further include indicating the SL positioning resource allocation in shared RP via new DCI format for UEs with SL positioning capability (_Rel-18). For UEs without SL positioning capability (<Rel-18), resources allocated are restricted for communication in shared RP via existing method of indication in DCI format 3_0 for backward compatibility.

In the second case, for SL positioning resource allocation like SL communication resource allocation in mode 2, the transmitting (TX) UE indicates SL positioning resource allocation in shared RP via a new 3rd-stage sidelink control information (SCI) and modifies 1st-stage SCI and 2nd-stage SCI. This may further include indicating SL positioning resource allocation in shared RP via new 3rd-stage SCI format for UEs with SL positioning capability (_Rel-18). For UEs without SL positioning capability (<Rel-18), resource reservation is indicated in 1st stage SCI for all UEs for backward compatibility.

An example context is shown in FIG. 4A for the first case, i.e. mode 1 for SL communication, whereby dynamic or configured grant (CG) resource allocation for SL positioning is carried out by the network gNB (or base station or device 104). At step 1 of the Figure, the gNB (or base station) sends dynamic or CG SL positioning resource allocation indication in shared RP to UEs with SL positioning capability (≥Rel-18) via new DCI format or a modified DCI format. At step 2, the UE with SL positioning capability (_Rel-18) receives the dynamic or CG SL positioning resource allocation in shared RP in the new DCI format. Subsequently at step 3, the UE uses allocated resources in the shared RP for SL positioning.

The new DCI format can include at least the following fields in addition or in combination with any subset of the fields already in DCI 3_0. One field may be frequency resource assignment for SL positioning where the location and number of subchannels to be used for positioning are specified. Another field may be time resource assignment for SL positioning where the symbols within a slot that are to be used for positioning are specified. Yet another field may be configuration indexes for SL positioning where the indexes can be used to indicate if the resource allocation is a CG (periodic/semi-persistent) or not (dynamic). The new DCI format may further include an indication if each of the above fields is shared with SL communication operation.

If any of the above discussed parameters are the same as a SL communication in the same shared RP, then two options are proposed for indication. Firstly, an additional bit in the corresponding field for SL communication indicates whether this field is shared by SL positioning, and a separate indication is not provided in the corresponding field for SL positioning. This can advantageously reduce the number of bits in DCI when some resources or configurations are shared between SL positioning and communication. Secondly, separate indications may always be used which can advantageously be easier for the UE to decode as DCI size will not change.

Alternatively, the new DCI format may carry an index which maps to a unique pattern of time and frequency resources, in addition to the configuration index. Such an index may be chosen by the UE (or user device) in its scheduling request (SR) for dynamic resource allocation or by the network gNB (or base station) for dynamic and/or CG resource allocation, depending on situations such as mobility, channel conditions etc. The mapping between the conditions and the index may be given by a pre-configured table in the higher layer. The tables can be defined separately for different ranges of such metrics as the available resources for positioning could be different due to adoption of congestion control mechanisms in the SL based on suitable metrics like CBR and CR. This can advantageously lead to a possibility to adjust resource allocation for communication and positioning in a dynamic manner having a lower amount of signaling overhead than explicitly indicating time-frequency resource assignments.

For UE without SL positioning capability (<Rel-18), the gNB (or base station) sends DCI format 3_0 for dynamic or CG SL communication resource allocation in shared RP at step 4. Specifically, the gNB (or base station) avoids or excludes allocating resources being used for SL positioning by Rel-18 UEs when allocating shared RP for communication. This can be done by suitably modifying parameters related to resource allocation for SL communication in DCI format 3_0. At step 5, the UE without SL positioning capability (<Rel-18) receives the dynamic or CG SL communication resource allocation in shared RP via DCI format 3_0 and at step 6, the UE uses allocated resources in the shared RP for SL communication.

FIG. 4B shows an example case of mode 1 for SL communication (or first communication mode), whereby dynamic or configured grant (CG) resource allocation for SL positioning is carried out by the network gNB (or base station or device 104). In the Figure, Rel-18 and beyond UE (or Rel-18 UE) sends SR for SL positioning resource allocation and the gNB allocates uplink (UL) resources for UE to send further details on required SL positioning resources. The UE may then send additional information on allocated UL resources and the gNB may send dynamic or CG resource allocation for SL positioning via the new DCI format. In this way, the gNB can avoid allocating these resources to other prior to Rel-18 UEs for SL communication by appropriate indication in DCI format 3_0.

In an embodiment, the gNB may also enable or disable monitoring of the UE. In a further embodiment, the gNB (or base station) can configure different monitoring configurations depending on a state status. For example, the gNB can configure SL positioning and monitoring information through dedicated DCI message. In another example, the gNB can configure SL positioning monitoring information through system information message. In yet another example, the gNB can configure SL positioning monitoring information through RRC release message.

FIG. 4C shows an example context of SL positioning resource allocation in mode 2 (or second communication mode), whereby the UE autonomously allocates resource for SL positioning. At step 1, the transmitting (TX) UE indicates resource reservation in 1st-stage SCI, which includes slots used for both SL communication and SL positioning. At step 2, specific SL positioning resource allocation information in new 3rd-stage SCI or SPCI is sent. In particular, for UE with SL positioning capability (≥Rel-18), the Rel-18 and beyond TX UE sends SL positioning resource allocation indication in shared RP via new 3rd-stage SCI or SL Positioning Control Information (SPCI) format. The TX UE may also send a modified 1 st-stage SCI format or a modified 2nd-stage SCI format or a combination of both. The new 3rd-stage SCI format may contain at least one of: priority for SL positioning, frequency resource assignment for SL positioning, time resource assignment for SL positioning and/or resource reservation period for SL positioning. The new 3rd-stage SCI format may also include Source ID for SL positioning, Destination ID for SL positioning and any other parameter necessary for SL positioning.

At step 3, the receiving UE receives the indication about SL positioning resources within the shared RP in the new 3rd-stage SCI format and subsequently uses allocated resources in shared RP for SL positioning at step 4. At step 5, the TX UE may use allocated resources in shared RP as indicated in the new 3rd-stage for SL positioning-related transmissions.

If any of the SL positioning parameters are the same as for SL communication in the same shared RP, then two options are proposed for indication. Firstly, additional reserved bits in 1st-stage SCI indicates whether any field is shared by SL positioning and a separate indication is not provided in 3rd-stage SCI. This can advantageously reduce signaling overhead when some resources or configurations are shared between SL positioning and communication. Secondly, separate indications may always be used which can advantageously be easier for other UEs to decode as the SCI size and format will not change.

Alternatively, a table can be pre-defined which maps requirements and conditions for positioning to a resource index instead of explicitly indicating the priority, time and/or frequency assignment and resource reservation period. Such a table can identify a unique combination of the time and frequency resource assignment for each priority value. The table itself may be defined at a higher layer and only the index maybe indicated in the SCI. The tables could be defined separately for different ranges of such metrics as the available resources for positioning could be different due to adoption of congestion control mechanisms in the SL based on suitable metrics like CBR and CR. This can advantageously lead to a possibility to adjust resource allocation for communication and positioning in a dynamic manner with lower amount of signaling overhead than explicitly indicating time-frequency resource assignments.

For UEs without SL positioning capability (<Rel-18), 1st-stage SCI may be transmitted by a Rel-18 and beyond TX UE using the shared RP for positioning. The 1st-stage SCI may indicate resource reservation for both SL positioning and communication. For prior to Rel-18, the TX UE performs sensing-based resource selection for SL communication. In other words, resources that are not already indicated to be reserved by other UEs in 1st-stage SCI for SL communication are used at step 6.

FIG. 4D shows an example context of a 3^{rd} stage SCI that is transmitted immediately following a 2^{nd} stage SCI for mode 2 (or second communication mode). The new 3rd-stage SCI may be transmitted within PSSCH, in any resource block (RB) within the same slot or any slot after the last slot of 2nd-stage SCI. Optionally, whether the new 3rd-stage SCI is transmitted and/or in which symbol within the PSSCH it will be transmitted may be indicated using reserved bits in 1 st-stage SCI in the corresponding PSCCH, e.g., using patterns 10 or 11 in the “2nd-stage SCI format” field or the other reserved bits in the 1st-stage SCI.

FIG. 4E shows an example case of mode 2 for SL communication (or second communication mode), whereby the UE autonomously allocates resource for SL positioning. In the Figure, Rel-18 and beyond TX UE (or Rel-18 UE) sends indication about reserved resources for SL communication and/or positioning using a combination of reserved bits and previous indications in 1st-stage SCI and newly proposed 3rd-stage SCI. The Rel-18 and beyond RX UE (or Rel-18 UE) receives both SL communication and SL positioning signals and the prior to Rel-18 TX UE (or <Rel-18 UE) performs sensing-based resource selection as usual. The prior to Rel-18 RX UE then receives SL communication signals on indicated resources.

In the foregoing manner, various embodiments of the disclosure are described for addressing at least one of the foregoing disadvantages. Such embodiments are intended to be encompassed by the following claims and are not to be limited to specific forms or arrangements of parts so described and it will be apparent to one skilled in the art in view of this disclosure that numerous changes and/or modification can be made, which are also intended to be encompassed by the following claims.

### Abbreviations

ACK: acknowledgement
AGC: automatic gain control
BSR: buffer status report
BWP: bandwidth part
CG: configured grant
CS-RNTI: configured scheduling radio network temporary identifier
DCI: downlink control information
GP: guard period
HARQ: hybrid automatic repeat request
NACK: negative acknowledgement
NDI: new data indicator
NR: new radio
OFDM: orthogonal frequency-division multiplexing
PRB: physical resource block
PRS: positioning reference signal
PSBCH: physical SL broadcast channel
PSCCH: physical SL control channel
PSFCH: physical SL feedback channel
PSSCH: physical SL shared channel
RAN: radio access network
RB: resource block
RP: resource pool
RRC: radio resource control
SCI: sidelink control information
SL: sidelink
SPCI: SL positioning Control Information
S-PSS: SL primary synchronization signal
SR: scheduling request
S-SS: SL synchronization signals
S-SSB: SL synchronization signal block
S-SSS: SL secondary synchronization signal
SL-RNTI: sidelink radio network temporary identifier
TB: transmission block
UE: user equipment
UL: uplink
WID: work item description

1. A method for allocating resources in a network, the method comprising:
determining a positioning configuration of a user device;
generating a control signal based on the configuration of the user device, the control signal comprising a first data format and a second data format; and
communicating the control signal to the user device for allocating resources to indicate a position of the user device;
wherein the first data format is transmitted to the user device if it is determined the user device has the positioning configuration and the second data format is transmitted to the user device if it is determined the user device does not have the positioning configuration.

2. The method according to claim 1, wherein the first data format comprises information associated with Downlink Control Information and Sidelink Control Information.

3. The method according to claim 2, where DCI comprises a new DCI format or a modified DCI format.

4. The method according to claim 3, wherein the new DCI format comprises at least one of: frequency resource assignment, time resource assignment and/or configuration indexes for sidelink positioning operation.

5. The method according to claim 4, wherein the new DCI format further comprises an indication if each of the frequency resource assignment, time resource assignment and configuration indexes is shared with sidelink communication operation.

6. The method according to claim 3, wherein the new DCI format further comprises an index to map frequency resource and time resource from a pre-determined table.

7. The method according to claim 2, wherein SCI comprises at least one of: a new SCI format, a modified first stage SCI format and/or a modified second stage SCI format.

8. The method according to claim 7, wherein the new SCI format comprises at least one of: a priority value, frequency resource assignment, time resource assignment, resource reservation period, source identification and/or destination identification.

9. The method according to claim 7, wherein the new SCI format further comprises an index to map frequency resource and time resource from a pre-determined table based on a priority value.

10. The method according to claim 1, wherein the second data format comprises information associated with DCI and SCI.

11. The method according to claim 10, wherein DCI comprises a modified DCI format to restrict resource allocation.

12. The method according to claim 10, wherein SCI comprises a first stage SCI format to indicate resource reservation.

13. The method according to claim 1, wherein determining the positioning configuration comprises determining a sidelink positioning capability of the user device.

14. A non-transitory computer program comprising instructions which, when the program is executed by a computer, cause the computer to carry out the method according to claim 1.

15. A non-transitory computer readable storage medium having data stored therein representing software executable by a computer, the software including instructions, when executed by the computer, to carry out the method according to claim 1.

16. A device for allocating resources in a network comprising:
a first module configured to obtain data associated with a positioning configuration of a user device;
a second module configured to at least one of process and facilitate the method of claim 1 in a first communication mode to generate at least one output signal; and
a third module configured to communicate at least one output signal, wherein the output signal corresponds to a control signal for allocating resources to indicate a position of the user device.

17. The device according to claim 16, wherein the first communication mode comprises at least one of: configured grant type sidelink positioning resource allocation and/or dynamic sidelink positioning resource allocation.

18. An apparatus for allocating resources in a network comprising:
a first module configured to obtain data associated with a positioning configuration of a user device;
a second module configured to at least one of process and facilitate the method of claim 1 in a second communication mode to generate at least one output signal; and
a third module configured to communicate at least one output signal,
wherein the output signal corresponds to a control signal for allocating resources to indicate a position of the user device.

19. The apparatus according to claim 18, wherein the second communication mode comprises allocation of sidelink positioning resources based on resource sensing and/or random selection.

20. The device and apparatus according to claim 16,
wherein the device corresponds to a base station communicable with the apparatus corresponding to a User Equipment, and
wherein the base station corresponds to a Next generation Node B configured to communicate the at least one output signal to the UE.

21. A system comprising:
at least one device according to claim 16; and
at least one apparatus
for allocating resources in a network comprising:
a first module configured to obtain data associated with a positioning configuration of a user device;
a second module configured to at least one of process and facilitate the method for allocating resources in a network, the method comprising:
determining a positioning configuration of a user device;
generating a control signal based on the configuration of the user device, the control signal comprising a first data format and a second data format; and
communicating the control signal to the user device for allocating resources to indicate a position of the user device;
wherein the first data format is transmitted to the user device if it is determined the user device has the positioning configuration and the second data format is transmitted to the user device if it is determined the user device does not have the positioning configuration in a second communication mode to generate at least one output signal; and
a third module configured to communicate at least one output signal,
wherein the output signal corresponds to a control signal for allocating resources to indicate a position of the user device,
wherein the apparatus and the device are capable of being coupled via at least one of wired coupling and wireless coupling.
